(19) United States
(12) Patent Application Publication
(10) Pub. No.: US 2018/0268672 A1
(43) Pub. Date: Sep. 20, 2018

(54) MERCHANDISE DISPLAY SECURITY DEVICE FOR HEADPHONES

(71) Applicant: InVue Security Products Inc., Charlotte, NC (US)

(72) Inventors: Jeffrey A. Grant, Charlotte, NC (US); Gary A. Taylor, Fort Mill, SC (US); David N. Berglund, Indian Trail, NC (US)

(21) Appl. No.: 15/751,028

(22) PCT Filed: Aug. 12, 2016
(86) PCT No.: PCT/US2016/046733

§ 371 Date: Feb. 7, 2018

Related U.S. Application Data
(60) Provisional application No. 62/205,041, filed on Aug. 14, 2015.

(51) Int. Cl. G08B 13/14

(52) U.S. Cl. CPC G08B 13/1454

(57) ABSTRACT

In one embodiment, a merchandise display security system for an article of merchandise is provided. The security system includes a cable comprising a plurality of conductors. The plurality of conductors is configured to transmit power and security signals or audio and security signals, and the plurality of conductors further configured to define a sense loop. The security system also includes a sensor operably engaged with the cable and configured to be removably attached to the headphones, and an alarm module for monitoring the status of the cable. The alarm module is configured to activate an alarm in response to interruption of the sense loop.

### CROSS REFERENCE TO RELATED APPLICATIONS

This application claims the benefit to priority of U.S. Provisional Patent Application No. 62/205,041 filed on Aug. 14, 2015, the entire disclosure of which is incorporated herein by reference.

### FIELD OF THE INVENTION

Embodiments of invention relate generally to merchandise display systems for displaying and protecting articles of merchandise from theft, including headphones.

### BACKGROUND OF THE INVENTION

Retailers routinely display electronic articles of merchandise, including media players and headphones, for a potential purchaser to examine before making a purchase. Retailers often desire the electronic articles of merchandise to be displayed in an operational mode so that the potential purchaser can evaluate the features and function of the merchandise as well. For example, the retailer might desire to permit a potential purchaser to experience the sound quality of audio equipment and components, such as headphones. At the same time, the retailer does not want the articles of merchandise being displayed to be stolen or removed from the display area by an unauthorized person. Accordingly, the articles of merchandise are oftentimes physically attached and/or electrically connected to a merchandise display security device that monitors and protects the article from the theft or removal.

### BRIEF SUMMARY OF THE INVENTION

Embodiments of the present invention are directed to merchandise display security systems and methods for displaying and protecting headphones from theft and unauthorized removal from a display area in a retail store. In one embodiment, the security system includes a cable, a sensor and an alarm module. The sensor may be operably engaged with the cable and may be configured to be removably attached to the headphones. The cable includes a plurality of conductors configured to define a sense loop. The plurality of conductors may be configured to transmit power and security signals or audio and security signals through the defined sense loop. The alarm module may be configured to monitor the status of the cable and activate an alarm in response to an interruption of the defined sense loop.

According to another embodiment, a method includes attaching a sensor to the headphones. The sensor is operably engaged with a cable comprising a plurality of conductors configured to define a sense loop. The plurality of conductors is configured to transmit power and security signals or audio and security signals. The method further includes connecting the cable to an alarm module for monitoring the status of the cable. The alarm module is configured to activate an alarm in response to interruption of the sense loop.

In one embodiment, a security device includes a cable, a sensor and an alarm module. The sensor may be operably engaged with the cable and may be configured to be removably attached to a pair of headphones. The cable includes a plurality of conductors configured to define a sense loop. The plurality of conductors may be configured to transmit power and security signals through the defined sense loop. The alarm module may be configured to monitor the status of the cable and activate an alarm in response to an interruption of the defined sense loop.

In another embodiment, a security device includes a cable, a sensor and an alarm module. The sensor may be operably engaged with the cable and may be configured to be removably attached to an article of merchandise on display in a retail store. The cable includes a plurality of conductors configured to define a sense loop. The plurality of conductors may be configured to transmit power, security and audio signals through the defined sense loop. The alarm module may be configured to monitor the status of the cable and activate an alarm in response to an interruption of the defined sense loop.

According to another embodiment, a method includes attaching a sensor to the article of merchandise on display. The sensor is operably engaged with a cable comprising a plurality of conductors configured to define a sense loop. The plurality of conductors is configured to transmit power and security signals or audio and security signals. The method further includes connecting the cable to an alarm module for monitoring the status of the cable. The alarm module is configured to activate an alarm in response to interruption of the sense loop.

### BRIEF DESCRIPTION OF THE DRAWINGS

FIG. 1 illustrates a merchandise display security system for displaying and protecting headphones according to one embodiment of the present invention;

FIG. 2 illustrates a recoiler and sensor for displaying and protecting headphones according to one embodiment of the present invention;

FIG. 3 illustrates a sensor and an audio adapter cable for displaying and protecting headphones according to one embodiment of the present invention;

FIG. 4 illustrates the sensor and the audio adapter cable of FIG. 3 connected to headphones for displaying and protecting headphones according to one embodiment of the present invention;

FIG. 5 illustrates a sensor and a power adapter cable for displaying and protecting headphones according to one embodiment of the present invention;

FIG. 6 illustrates the sensor and the power adapter cable of FIG. 5 connected to headphones for displaying and protecting the headphones according to one embodiment of the present invention;

FIG. 7 illustrates cables for providing power, security, and audio signals for displaying and protecting headphones according to one embodiment of the present invention; and

FIG. 8 illustrates an alarm module for displaying and protecting headphones according to one embodiment of the present invention.

### DETAILED DESCRIPTION OF EMBODIMENTS OF THE INVENTION

Referring now to the accompanying drawing figures wherein like reference numerals denote like elements throughout the various views, embodiments of merchandise security systems and methods for displaying and protecting an article of merchandise are shown. More particularly, some embodiments are provided for a merchandise display security system for displaying and protecting headphones, indicated generally by reference character “H”, from theft or removal. In some embodiments, the merchandise display security system is configured to activate an audible and/or visible alarm in the event that the headphones are separated from the security system. In addition, the merchandise display security system may be configured to display and protect the headphones H, while at the same time permitting a potential purchaser to evaluate the operation of the headphones H. Although the following description is discussed in conjunction with headphones, it is understood that embodiments of the present invention are applicable to a variety of different types of articles of merchandise (e.g., cellular phones, tablets, computers, cameras, etc.).

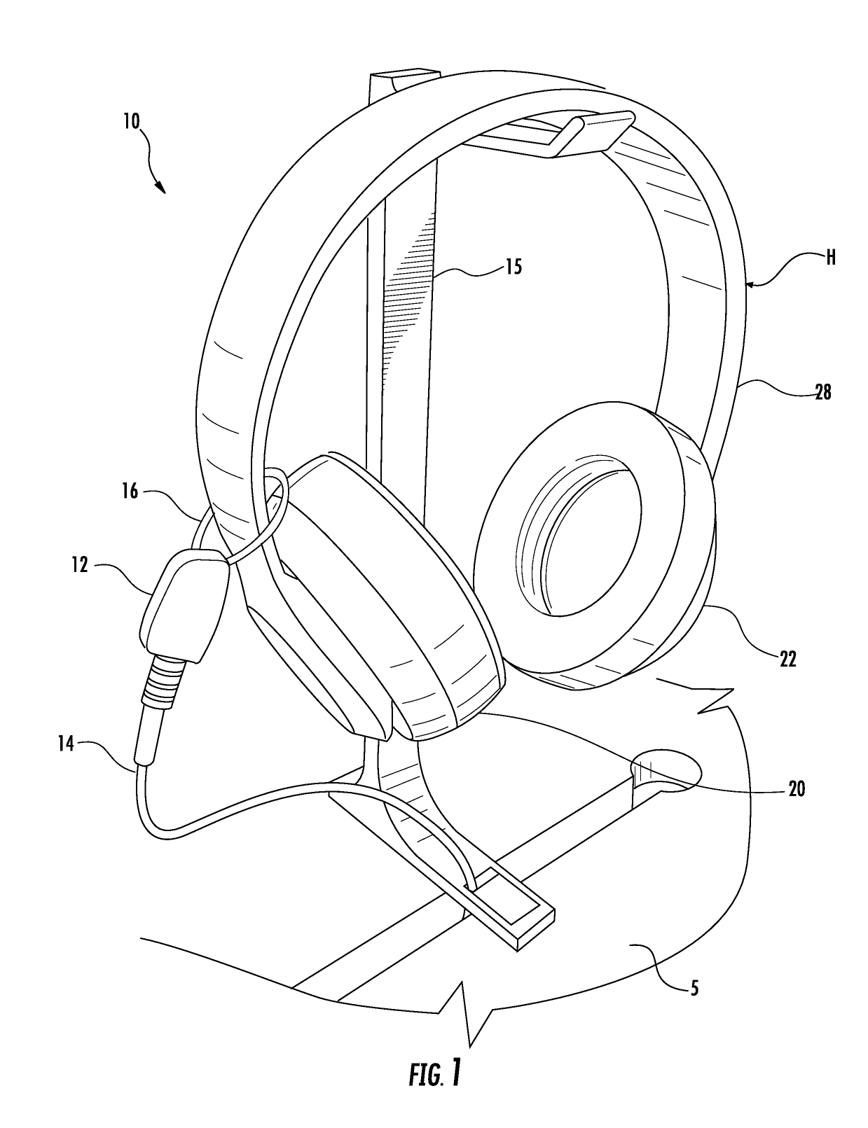

FIG. 1 illustrates one embodiment of a merchandise display security system 10 for displaying and protecting headphones H from theft or removal by an unauthorized person from a display area of a retail store. The headphones H may be any conventional type, model or style configured to communicate with a media player for receiving audio signals. For instance, the headphones may be wireless and be configured to receive audio signals wirelessly from a media player (e.g., via Bluetooth communication), or the headphones may be operably engaged with a conventional audio cord having an audio plug for engaging an audio jack on the media player. Moreover, in some cases, the headphones may include a power input port for receiving a power connector for charging the headphones. Thus, the headphones may include a power source for performing various functions, such as wireless communication.

The security system 10 includes a display stand 15 configured to support the headphones H thereon. The security system 10 may further include a sensor 12 configured to be attached to the headphones. The sensor 12 may be attached to the headphones H using various techniques, such as adhesive and/or fasteners. In some cases, the sensor includes a loop 16 or noose configured to be wrapped about a portion of the headphones H for securing the sensor thereto. An end of the loop 16 is configured to be removed from the sensor 12 and inserted within the sensor, and the loop may be adjustable to different diameters. The loop 16 may also include one or more conductors configured to transmit security signals and to define a sense loop therethrough. In other cases, the sensor 12 includes a pressure or plunger switch configured to engage the headphones H when secured thereto. The pressure or plunger switch may be configured to detect when the sensor 12 is removed from the headphones H in an unauthorized manner.

The sensor 12 may be operably engaged with a cable 14. The cable 14 may be operably engaged with a recoiler 18 at one end for retractably storing the cable. The cable 14 is configured to be extended and retracted relative to the recoiler 18 for allowing a user to examine and evaluate the features of the headphones H. The recoiler 18 may be located at a remote location from the headphones H, such as below a counter or other support surface “S” as shown in FIG. 1. Due to the lower power requirements of headphones H in comparison to other portable electronic devices such as mobile phones and tablets, the diameter of the conductors in the cable 14 for providing power may be reduced, thereby resulting in a smaller diameter cable and a lighter pull force on the cable for extending the cable and a more flexible cable.

The cable 14 includes a plurality of conductors for transmitting power, audio, and/or sense signals. In one embodiment, the cable 14 is configured to transmit power, audio, and sense signals, while in other embodiments, the cable may be configured to transmit power and sense signals or audio and sense signals. For example, where the headphones have wireless capability, the cable 14 may be configured to only transmit power and sense signals, but where the headphones are not wireless, the cable may be configured to transmit at least audio and sense signals.

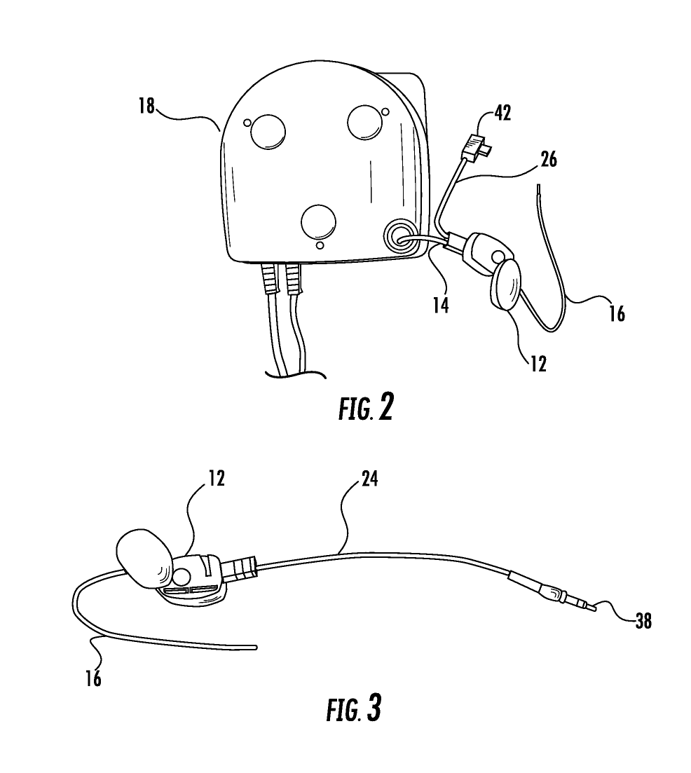

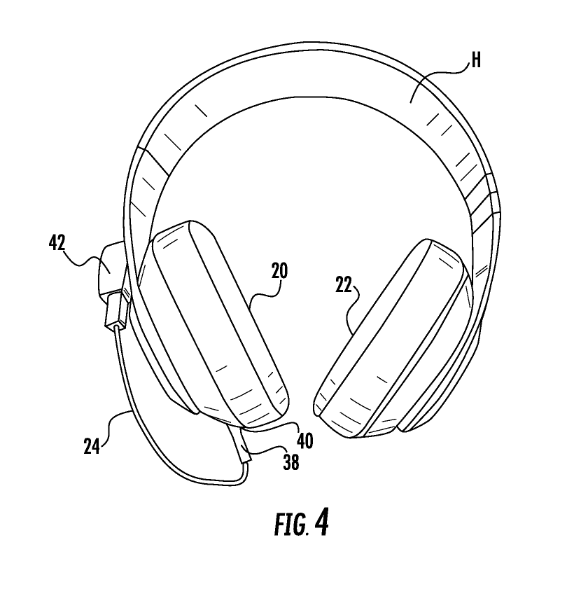

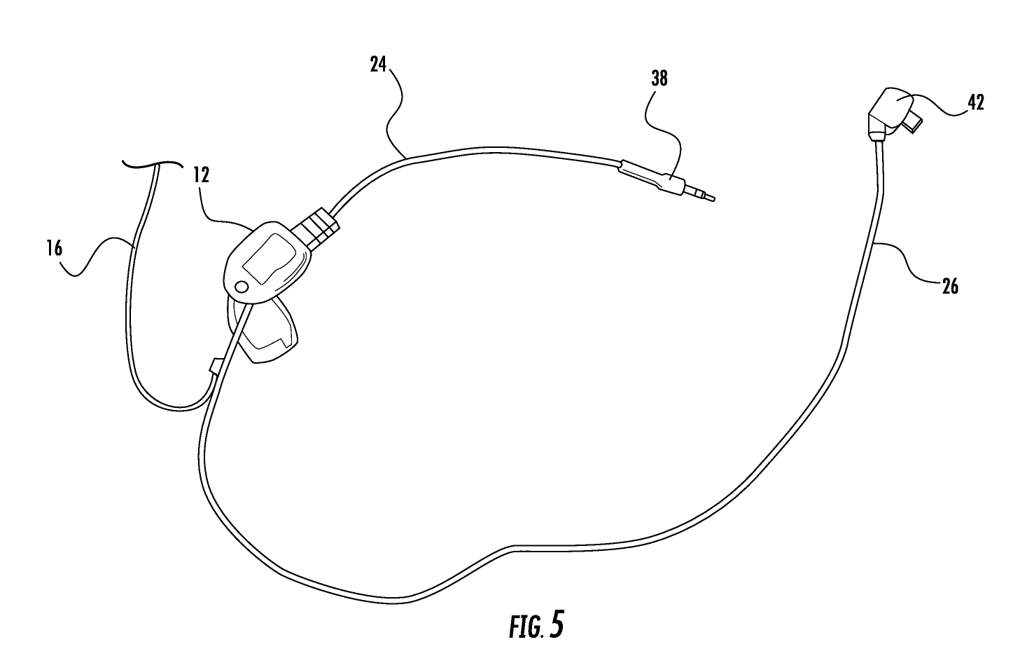

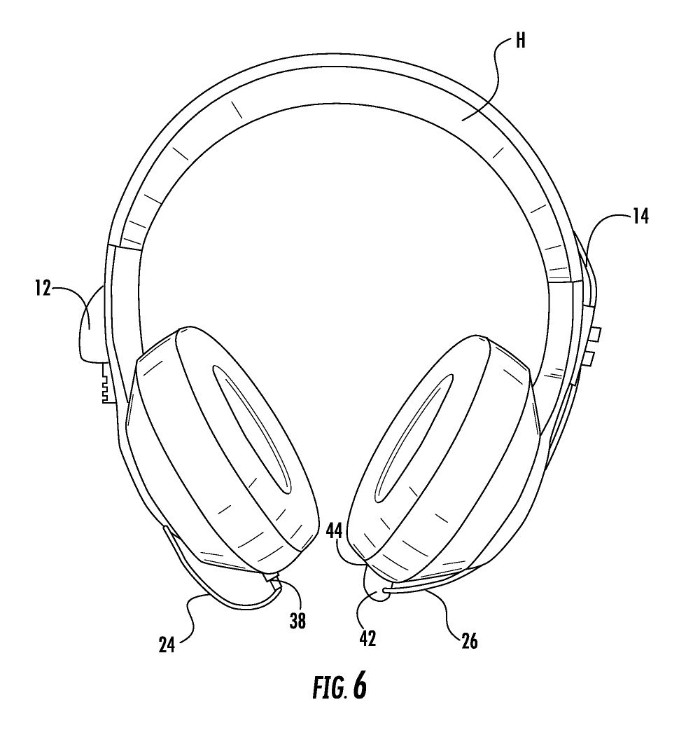

In a conventional manner, the headphones H may have a pair of earpieces 20, 22 (e.g. left and right) and an adjustable strap 28 extending therebetween. The sensor 12 may be configured to be attached to either one of the earpieces 20, 22. The sensor 12 may include an audio adapter cable 24 that is operably engaged with the sensor 12 and includes a plug 38 at its free end for engaging an audio jack 40 provided on the headphones H (see, e.g., FIGS. 3-4). Thus, the sensor 12, in combination with the cable 14 and audio adapter cable 24, may be configured to transmit audio signals to the headphones H. In another embodiment, the sensor 12 may include a power adapter cable 26 that is operably engaged with the sensor 12 and includes a connector 42 at its free end for engaging a power input port 44 on the headphones (see, e.g., FIG. 2 and FIG. 6). The connector 42 may be any suitable connector type depending on the type of headphones (e.g., a micro-USB or USB-C connector). Thus, the sensor 12, in combination with the cable 14 and power adapter cable 26, may be configured to transmit power signals to the headphones H. In some instances, the sensor 12 may be operably engaged with both an audio adapter cable 24 and a power adapter cable 26 (see, e.g., FIG. 5). If the audio jack 40 and the power input port 44 are located on different earpieces 20, 22, either one of the audio adapter cable 24 and power adapter cable 26 may be routed from the sensor 12 attached to one of the ear pieces 20, 22 about the adjustable strap 28 to the other earpiece 20, 22 (see, e.g., FIG. 6). Advantageously, only a single cable 12 is required between the headphones H and the recoiler 18. Thus, additional cables for providing audio and/or power signals are eliminated.

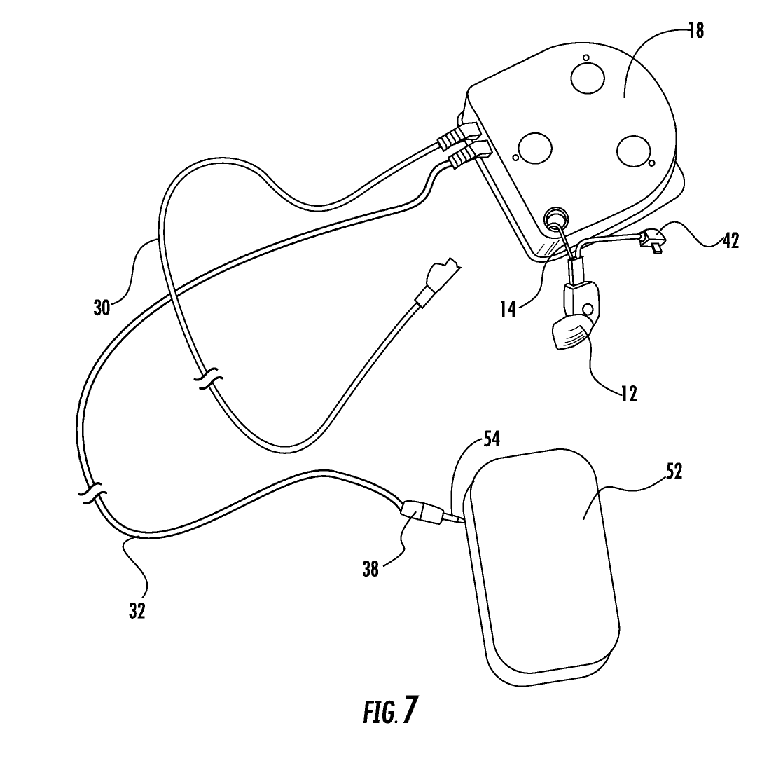

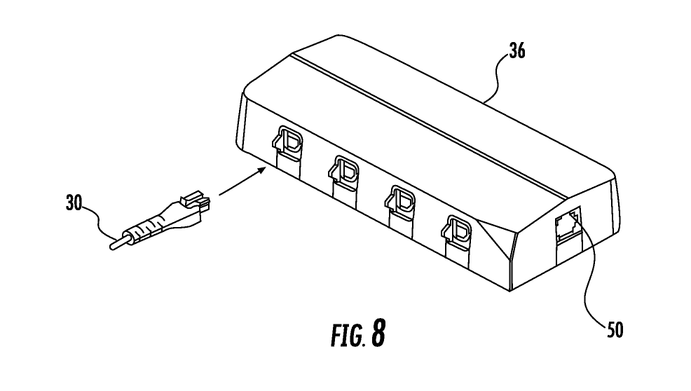

The cable 14 may be operably engaged with an alarm module 36 (see, e.g., FIG. 8). The alarm module 36 may be located at a remote location from the headphones H, such as below a counter or other support surface S. In other embodiments, the alarm module 36 may be integrated with the display stand 15. The cable 14 may be directly connected to the alarm module 36 or could be indirectly connected to the alarm module 36. In one example, the recoiler 18 may be electrically connected to the cable 14, and the recoiler 18 may in turn be electrically connected to an alarm module 36. The alarm module 36 may include an input port 50 for receiving an end of the cable 14 or another cable connecting the recoiler 18 to the alarm module 36. The alarm module 36 or recoiler 18 may also be operably engaged with an audio plug 38 configured to engage an audio jack 54 on a media player 52. For example, FIG. 7 shows that the recoiler 18 may include a first cable 30 for providing power and/or sense signals and a second cable 32 for providing audio signals. The first 30 and second 32 cables may be electrically connected to the recoiler 18 and the cable 14. The first cable 30 may be configured to operably engage the alarm module 36 (see, e.g., FIG. 8), while the second cable 32 may be configured to operably engage the audio jack 54 of the media player 52.

The alarm module 36 may include an internal electrical control circuit, also referred to herein as power electronics and/or sensor electronics. The sensor electronics in the alarm module 36 may monitor the state of the sense loop defined through the sensor 12 and cable 14, and in some instances, the audio adapter cable 24 and/or power adapter cable 26. For example, the sensor electronics may monitor whether the headphones H have become detached from the sensor 12. The merchandise display security system 10 may include an audible and/or visible alarm in electrical communication with the electrical control circuit disposed within the alarm module 36 that is activated in response to a security event. The electronics disposed within the alarm module 36 may monitor the status of the cable 14 and activate the alarm if the cable 14 is severed (e.g. electrical continuity along the conductors of the cable is interrupted), the sensor 12 is detached from the headphones H, if the audio adapter cable 24 is unplugged from the headphones, or if the power adapter cable 26 is unplugged from the headphones. Accordingly, the control electronics and the sensor electronics may be disposed within the alarm module 36 of the security system. As such, the cable 14 electrically connects the headphones H directly to the control electronics and the sensor electronics disposed within the alarm module 36.

Embodiments of a merchandise display security system have been shown and described herein for purposes of illustrating and enabling the best mode of the invention. Those of ordinary skill in the art, however, will readily understand and appreciate that numerous variations and modifications of the invention may be made without departing from the spirit and scope of the invention. Accordingly, all such variations and modifications are intended to be encompassed by the appended claims.

1. A merchandise display security system for headphones, the merchandise display security system comprising:
a cable comprising a plurality of conductors, the plurality of conductors configured to transmit power and security signals or audio and security signals, the plurality of conductors further configured to define a sense loop;
a sensor operably engaged with the cable and configured to be removably attached to the headphones; and
an alarm module for monitoring the status of the cable, wherein the alarm module is configured to activate an alarm in response to interruption of the sense loop.

2. The merchandise display security system according to claim 1, further comprising an audio adapter cable operably engaged with the sensor and comprising a plug configured to engage an audio jack on the headphones.

3. The merchandise display security system according to claim 1, further comprising a power adapter cable operably engaged with the sensor and comprising a connector configured to engage a power input port on the headphones.

4. The merchandise display security system according to claim 1, wherein the plurality of conductors is configured to transmit audio, security, and power signals.

5. The merchandise display security system according to claim 1, wherein the alarm module is configured to activate an alarm in response to the cable being severed or the sensor being separated from the headphones.

6. The merchandise display security system according to claim 1, wherein the cable comprises separate conductors for transmitting the power and security signals or the audio and security signals.

7. The merchandise display security system according to claim 1, wherein the cable is operably engaged with a recoiler.

8. The merchandise display security system according to claim 7, wherein the recoiler is operably engaged with the alarm module, and wherein the recoiler comprises a plug configured to engage an audio jack on a media player for providing audio signals to the headphones.

9. The merchandise display security system according to claim 1, wherein the cable is configured to transmit audio signals from a media player.

10. The merchandise display security system according to claim 1, wherein the headphones are configured to wirelessly communicate with a media player for receiving audio signals from the media player.

11. A method for securing headphones from theft, the method comprising:
attaching a sensor to the headphones, the sensor operably engaged with a cable comprising a plurality of conductors, the plurality of conductors configured to transmit power and security signals or audio and security signals, the plurality of conductors further configured to define a sense loop; and
connecting the cable to an alarm module for monitoring the status of the cable, wherein the alarm module is configured to activate an alarm in response to interruption of the sense loop.

12. The method of claim 11, wherein the plurality of conductors is configured to transmit power, security, and audio signals.

13. The method of claim 11, further comprising engaging a plug of an audio adapter cable operably engaged with the sensor with an audio jack on the headphones.

14. The method of claim 11, further comprising engaging a connector of a power adapter cable operably engaged with the sensor with a power input port on the headphones.

15. A merchandise display security system for headphones, the merchandise display security system comprising:
a cable comprising a plurality of conductors, the plurality of conductors configured to transmit power and security signals, the plurality of conductors further configured to define a sense loop;
a sensor operably engaged with the cable and configured to be removably attached to headphones; and
an alarm module for monitoring the status of the cable, wherein the alarm module is configured to activate an alarm in response to interruption of the sense loop.

16. The merchandise display security system according to claim 15, wherein the cable is configured to transmit audio signals.

17. The merchandise display security system according to claim 15, wherein the headphones are configured to wirelessly communicate with a media player for receiving audio signals from the media player.

18. (canceled)

19. (canceled)
